(19) United States
(12) Patent Application Publication
(10) Pub. No.: US 2024/0377824 A1
(43) Pub. Date: Nov. 14, 2024

(54) MULTIPLE VEHICLE SYSTEM

(71) Applicants: Hyundai Motor Company, Seoul (KR); Kia Corporation, Seoul (KR)

(72) Inventors: Ernestine Fu, Somerville, MA (US); John Suh, Palo Alto, CA (US)

(21) Appl. No.: 18/316,299

(22) Filed: May 12, 2023

(51) Int. Cl. G05D 1/02; B64C 39/02; B64U 50/37; B64U 80/25; B64U 80/86; G05D 1/00; G05D 1/10

(52) U.S. Cl. CPC G05D 1/021; B64C 39/024; B64U 50/37; B64U 80/25; B64U 80/86; B64U 2101/30; B64U 2201/20

(57) ABSTRACT

A combination two vehicle system includes a ground-based vehicle configured for traversal over ground using walking locomotion and an aerial drone configured for travel through air, where the aerial drone is configured to detachably couple with the walking vehicle.

### FIELD

In one aspect, a multiple vehicle system is provided that includes a ground-based vehicle configured for traversal over ground using walking locomotion and an aerial drone configured for travel through air, where the aerial drone is configured to detachably couple with the walking vehicle.

### BACKGROUND

Underground mining operations to extract materials from within the Earth have long provided civilization with resources. Over the last century, underground mining operations have become increasingly sophisticated, as the need to extract rare-earth metals and other important materials from the Earth has increased.

As the size and sophistication of underground mines has grown, new systems are needed to improve the extraction operations.

### SUMMARY

In one aspect, we now provide an autonomous vehicle capable of walking locomotion that includes at least one removable aerial drone.

The autonomous walking vehicle and the at least one aerial drone are configured for cooperative use. In some embodiments, the autonomous walking vehicle delivers the aerial drone to a remote location, where the two vehicles operate cooperatively to perform 360-degree scanning of an area. In certain aspects, the aerial drone and the autonomous walking vehicle are operable to provide other cooperative or symbiotic operations to remotely explore underground regions, such as mines or natural caverns.

In a preferred aspect, a vehicle system is provided that comprises: 1) a ground-based vehicle component configured for traversal over ground using walking locomotion; and 2) an aerial vehicle component, wherein the land-based vehicle and aerial vehicle components are releasably coupled.

In an embodiment, the aerial vehicle component is a drone.

In an embodiment, the vehicle system is not configured for passenger transport. In one aspect, the entire vehicle system is configured to be operated autonomously. For example, in an aspect, the ground-based vehicle component and/or the aerial component are operated remotely. In such aspects, the vehicle system may be smaller than required for passenger transport, for instance, the vehicle system may have a length of less than 14, 12, 10, 8, 6, 4, 3 or 2 feet, and a height less than 12, 10, 8, 6, 5, 4, 3, or 2 feet. In one system, the vehicle system has a length 10, 8, 6 or 4 feet or less and a height less than 6, 5, 4 or 3 feet or less. In one system, the vehicle system has a length of 8 feet or less and a height of 5 feet or less. In one configuration, the vehicle system has a length less than 6 feet and a height less than 4 feet. In a further configuration, the vehicle system has a length less than 6, 5, 4 or 3 feet and a height less than 4, 3 or 2.5 feet.

The ground-based vehicle component and aerial vehicle component may be coupled by a variety configurations, including multiple engagements. Suitably, the aerial vehicle component comprises a connection mechanism for detachable coupling with the ground-based vehicle component.

In a preferred aspect, the ground-based vehicle component and the aerial vehicle component are coupled via a data communication connection.

In a preferred aspect, the ground-based vehicle and the aerial vehicle are coupled via an electrical connection. For example, the electrical connection is suitably configured to provide a power transmission between the ground-based vehicle component and the aerial vehicle component, wherein the power transmission is configured to charge a battery of the ground-based vehicle component and/or the battery of the aerial vehicle component.

In preferred systems, the ground-based vehicle component comprises a removable cargo pod. Preferably, the aerial vehicle component is configured to travel with the removable cargo pod independent of the ground-based vehicle. Preferably, the aerial vehicle component comprises a unit to retrieve the removable cargo pod from the ground-based vehicle.

In certain aspects, the aerial vehicle component comprises one or more rotary wings.

Suitably, the ground-based vehicle and aerial vehicle components are configured to be operated in combination or separately.

As discussed, preferably, the ground-based vehicle and/or the aerial vehicle components are configured to be operated autonomously.

Preferably, wherein aerial vehicle comprises electronics for performing cave mapping, including surveilling underground mines or other areas that are difficult to access with traditional wheeled ground vehicles.

In further aspects, methods for operating a vehicle system are provided that comprise: (a) providing a vehicle system that comprises a (i) a ground-based vehicle component and (ii) an aerial vehicle component, wherein the ground-based vehicle component and aerial vehicle component are releasably engaged; (b) disengaging the ground-based vehicle component and the aerial vehicle component; and (c) autonomously operating the aerial vehicle component. In certain embodiments, the ground-based vehicle component remains stationary while the aerial vehicle component is operated. In certain embodiments, the vehicle system is positioned within a cave including underground mines or other areas that are difficult to access with traditional wheeled ground vehicles.

An autonomous vehicle or vehicle component as referred to herein may include a vehicle or vehicle component that is capable of navigating with little or no user input, such as by sensing its environment.

Other aspects are disclosed infra.

### BRIEF DESCRIPTION OF THE DRAWINGS

FIG. 1 is a diagram illustrating a walking vehicle including an aerial drone, according to some embodiments.

FIGS. 2A and 2B are diagrams illustrating an example wheel-leg component in retracted and extended positions, according to embodiments.

FIG. 3 is an illustration of a walking vehicle autonomously navigating an underground cavern or mine, according to some embodiments.

FIGS. 4A and 4B are illustrations of a walking vehicle with an attached aerial drone navigating an underground cavern or mine while being controlled remotely by a human operator, according to some embodiments.

FIG. 5 is an illustration of a walking vehicle with an attached aerial drone performing a mapping operation within a mine, according to some embodiments.

FIG. 6 is an illustration of a walking vehicle and an aerial drone performing a mapping operation within a mine, according to some embodiments.

FIGS. 7A through 7C illustrate perspective views of different walking gaits of the walking vehicle, according to some embodiments.

### DETAILED DESCRIPTION

Cave mapping is a process whereby the interior passages and caverns of caves are mapped. Traditionally, cave mapping was a laborious manual operation, whereby one or more humans would explore a cave, make interior measurements during the exploration, and use the measurements and observations to manually sketch or otherwise represent the interior passages of the cave into a map. As technology has advanced, different types of electronic devices can be used to map caves, such as digital cameras, three-dimensional (3D) cameras, sonar devices, ultrasound devices, etc.

Embodiments described herein leverage the mobility and maneuverability of the autonomous walking vehicle to navigate through a mine or natural cavern, while transporting at least one aerial drone to a location within the mine or cavern. The autonomous walking vehicle is able to navigate to the location using walking ambulation. The aerial drone is equipped with at least one camera or electronic device capable of performing cave mapping. While the autonomous vehicle is navigating the mine or cavern, the aerial drone is configured to perform mapping operations using the electronic device for mapping.

Because exploring mines and natural caverns can be dangerous, the described embodiments can be used to remotely investigate the interior of a mine, including the hard to reach features. In some embodiments, a 360-degree camera system is used by the aerial drone to take detailed images and transmit them back to a human operator for analysis. The described embodiments can lead human teams in and out of difficult to assess locations. In some embodiments, the walking vehicle and the aerial drone are able to access dangerous locations, such as deep mines, to retrieve data or physical samples. In some embodiments, the walking vehicle can deliver fully charged aerial drones to remote locations and assist in 360 degree scanning.

Despite the enhanced maneuverability of the autonomous walking vehicle, many mines or natural caverns include passages, crevasses, or other formations that the autonomous walking vehicle will not be able to reach, such as an elevated passage, a deep depression, or other types of inaccessible regions. Upon identifying an inaccessible region, the aerial drone is able to detach from the autonomous walking vehicle and continue with exploration of the inaccessible regions independent of the autonomous walking vehicle. This allows for the continued exploration of the cavern without requiring the use of the autonomous walking vehicle.

In some embodiments, the walking vehicle is capable of being controlled remotely, e.g., by an operator within the cavern or outside the cavern. In some embodiments, the walking vehicle provides charging capabilities to the attached aerial drone. The aerial drone can explore a region of a cavern or mine and, if its power supply is running low, return to the walking vehicle for recharging. It should be appreciated that the electrical connection for providing power can be wired connection or a wireless connection.

In some embodiments, the walking vehicle with an aerial drone described herein can be used in search and rescue operations. Mine caves ins are an unfortunate side effect of underground mining operations. The aerial drone described herein can, operating in conjunction with the walking vehicle, reach locations close to a cave in that might not otherwise be accessible by the walking vehicle or humans. In some embodiments, the aerial drone can deliver goods (e.g., food, water, oxygen) to a site of a cave in, if there is an opening, to any persons in the cave for assisting in rescue efforts.

In another embodiment, the walking vehicle also includes a cargo pod that can detach from the chassis of the walking vehicle. In some embodiments, the cargo pod removed from the walking vehicle can be carried by the aerial drone and delivered to another location within the cavern or mine.

In certain embodiments, an autonomous vehicle is provided that capable of walking locomotion that includes at least one removable aerial drone. The autonomous walking vehicle and the at least one aerial drone are configured for cooperative use. In some embodiments, the autonomous walking vehicle delivers the aerial drone to a remote location, where the two vehicles operate cooperatively to perform scanning or other detection of an area, include 360-degree scanning of an area. In accordance with some embodiments, the aerial drone and the autonomous walking vehicle are operable to provide other cooperative or symbiotic operations to remotely explore underground regions, such as mines or natural caverns.

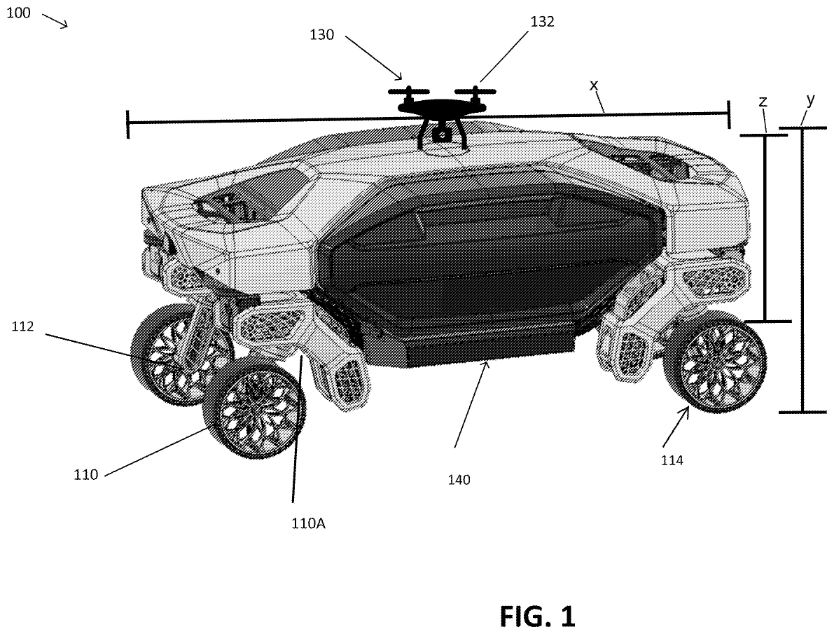

FIG. 1 is a diagram illustrating a walking vehicle 100 including an aerial vehicle shown as aerial drone 130, according to some embodiments. Aerial drone 130 with depicted one or more rotary wings 132 is configured to removably couple to walking vehicle 100 for conveyance by walking vehicle 100 from a first location to a second location. Walking vehicle 100 and aerial drone 130 suitably can leverage the efficiency of land-based travel through a mine or cave to a launching point, where aerial drone 130 can release from walking vehicle 100 and perform air-based operations, such as cave mapping. It should be appreciated that walking vehicle 100 can include and/or transport more than one aerial drone 130.

In some embodiments, walking vehicle 100 is configured for autonomous navigation, such that walking vehicle 100 can navigate throughout a mine or cave structure without human control. In other embodiments, walking vehicle 100 is controlled remotely by a human operator. It should be appreciated that any combination of autonomous and remote control can be used to control walking vehicle 100. For example, walking vehicle 100 may operate autonomously until a destination is reached or an obstacle is encountered, at which point a human operator may take control. In some embodiments, walking vehicle 100 and aerial drone 130 include cameras for displaying a position to a human operator. While walking vehicle 100 is described herein as an uncrewed vehicle, it should be appreciated that in some embodiments walking vehicle 100 is configured to carry human passengers.

In accordance with various embodiments, walking vehicle 100 provides movement capability of rolling motion and walking motion, referred to herein as wheel-leg locomotion, that may be used in remotely controlled or autonomous vehicles. Such articulation in movement enables exploration of extreme off-road terrains using walking gaits, as well as travel across roads using efficient rolling modes. For instance, walking vehicle 100 can scale rough rocks that would otherwise be untraversable using a conventional vehicle. Simultaneously, it is also a practical vehicle that can traverse both paved and unpaved roads using driven wheel locomotion. This dual-domain is enabled by using wheel-leg locomotion. For example, when used in an underground mine, walking vehicle 100 is capable of wheeled locomotion over flat terrain and is capable of walking locomotion over rugged and extreme terrain.

Walking vehicle 100 suitably includes multiple (e.g. four or more) wheel-leg components shown as 110, 112, 114 in FIG. 1 that include at least two degrees of freedom. In one embodiment, wheel-leg components 110 include six degrees of freedom. It should be appreciated that while multiple wheel-leg components (such as 110, 112, and 114 shown in FIG. 1) are preferably controlled collectively to provide rolling and walking locomotion, each wheel-leg component is preferably capable of different movement or positioning during operation. For example, while using wheeled locomotion on an upward slope, in order to maintain the body of vehicle 100 level with flat ground, the front wheel-leg components 110, 112 may be retracted and the rear wheel-leg components 114 and others may be extended. In another example, while using walking locomotion to traverse rough terrain, each wheel-leg component, or opposite pairs of wheel-leg components (e.g., front left and rear right), can move differently than the other wheel-leg components. In one configuration, a wheel-leg component suitably includes retractable leg comments shown as 110A in FIG. 1.

In some embodiments, walking vehicle 100, includes at least one cargo pod 140 for storing cargo. Walking vehicle 100 is configured to receive and transport cargo pod 140. In some embodiments, aerial drone 130 is also capable of receiving and transporting cargo pod 140, subject to weight and size restrictions.

FIG. 1 depicts one preferred vehicle system 100 that includes aerial drone 130, also referred to herein as an uncrewed aerial vehicle (UAV), is an aircraft that is capable of autonomous or remotely controlled air travel. Aerial drone 130 is equipped with at least one camera or electronic device capable of performing cave mapping. While walking vehicle 100 is navigating the mine or cavern, aerial drone 130 is configured to perform mapping operations using the electronic device for mapping. For example, the electronic device for mapping can include a digital camera, a 3D camera, a sonar device, an ultrasound device, etc.

Aerial drone 130 is electrically powered, and is capable of electrically coupling with walking vehicle 100. In some embodiments, aerial drone 130 includes a battery for storing power. In one embodiment, walking vehicle 100 is configured to charge the battery of aerial drone 130 (e.g., during land traversal). It should be appreciated that the electrical connection for providing power can be wired connection or a wireless connection.

Embodiments described herein leverage the mobility and maneuverability of walking vehicle 100 to navigate through a mine or natural cavern, while transporting at least one aerial drone 130 to a location within the mine or cavern. Walking vehicle 100 is able to navigate to the location using walking ambulation. Aerial drone 130 is equipped with at least one camera or electronic device capable of performing cave mapping. While the autonomous vehicle is navigating the mine or cavern, aerial drone 130 is configured to perform mapping operations using the electronic device for mapping.

It should be appreciated that various design considerations and optimizations are taken into account when designing combination walking vehicle 100 and aerial drone 130 based on potential use cases.

In accordance with various embodiments, aerial drone 130 is capable of remote operation, autonomous operation, or a combination of remote and autonomous operation. For example, a user may be able to remotely control operation of aerial drone 130, such as from a command center. In other examples, aerial drone 130 is configured to operate autonomously, such that a destination is provided and aerial drone 130 is capable of self-navigating to the destination.

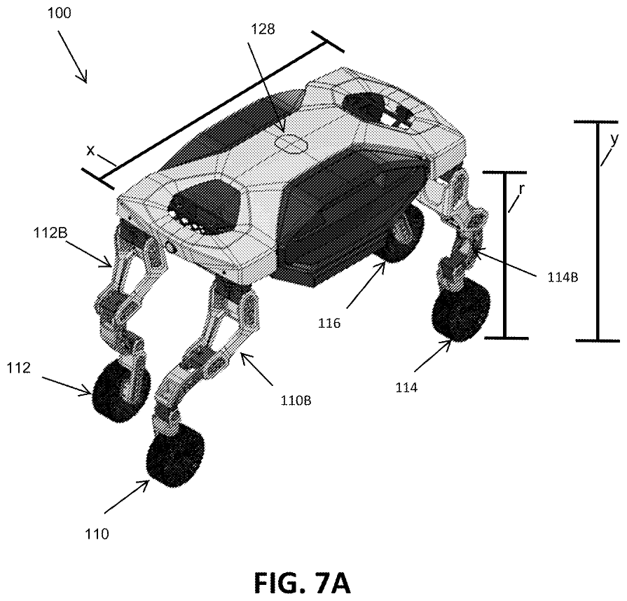

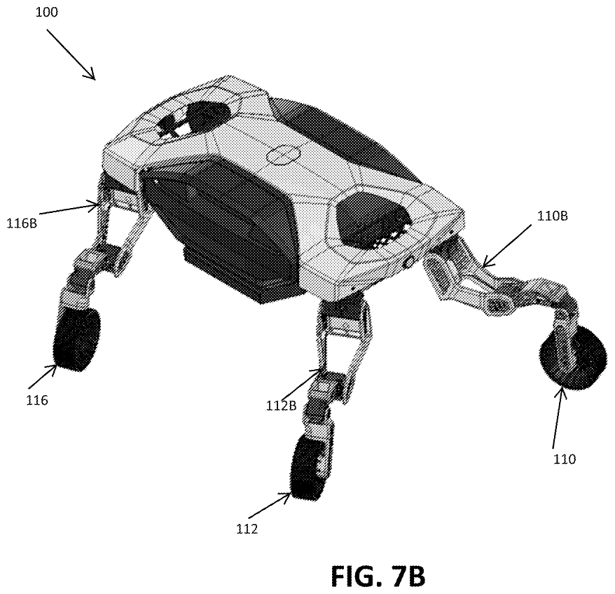

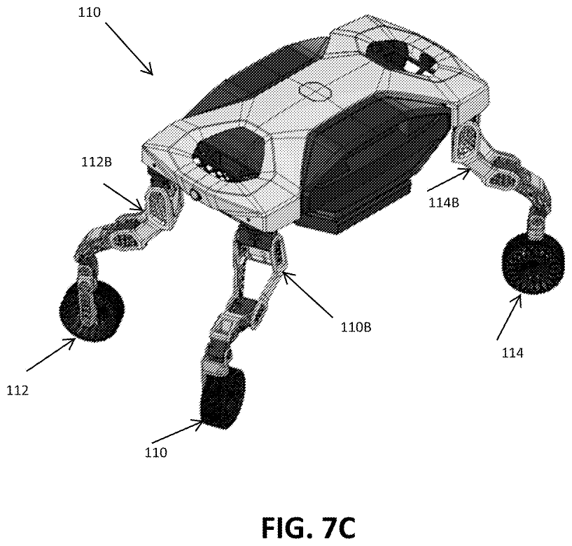

As discussed, vehicle 100 suitably may have varying dimensions. For instance, in certain preferred systems, a vehicle 100 may have a length (length shown as “x” in FIGS. 1 and 7A) of less than 20, 18, 16, 14, 12, 10, 8, 6, 4, 3 or 2 feet, and a height length (shown as “y” in FIGS. 1 and 7A) less than 16, 14, 12, 10, 8, 6, 5, 4, 3, or 2 feet. The length dimension x as depicted in FIGS. 1 and 7A may be defined as the distance between the most forward point and the most rearward point of the vehicle. The height dimension y as depicted in FIGS. 1 and 7A may be defined as the distance between the top or highest vehicle surface and the ground plane on which the vehicle is positioned.

The vehicle 100 cabin also may have varying dimensions. For instance, in certain preferred systems, a vehicle cabin height depicted as z in FIG. 1 suitably may be 12, 10, 8, 6, 4, 3, 1 or 0.5 feet or less. The vehicle height z may be defined as the distance the top or highest vehicle cabin and lowest point of the vehicle cabin (would not include wheel-leg components).

In certain systems, the vehicle system has a length (x in FIGS. 1 and 7A) of 10, 8, 6, 4, 3 or 2 feet or less and a height (y in FIGS. 1 and 7A) of less than 6, 5, 4 or 3 feet or less. In certain systems, the vehicle system has a length of 8 feet or less and a height of 5 feet or less. In such systems, the vehicle also may have a cabin height (z in FIG. 1) of 8, 6, 4, 3, 1 or 0.5 feet or less.

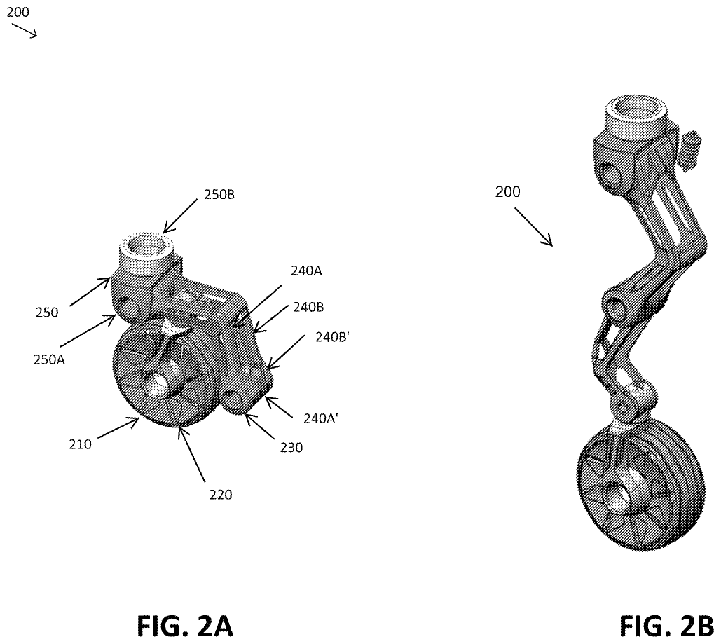

FIGS. 2A and 2B depict certain preferred wheel-leg components 200. FIGS. 2A and 2B are diagrams illustrating an example wheel-leg component in retracted and extended positions, according to embodiments. Various embodiments of such wheel-leg components are described in co-pending U.S. patent application Ser. No. 16/734,310 (U.S. Patent Application Publication No. 2020/0216127). With reference to FIG. 2A, the wheel-leg component is in a retracted state, with the wheel-leg component capable of providing wheeled locomotion. With reference to FIG. 2B, the wheel-leg component is in an extended state, with the wheel-leg component capable of providing walking locomotion.

As illustrated, in FIG. 2A, wheel-leg components 200 of the vehicle 100 are retracted, providing a rolling locomotion mode for use on roads or other flat surfaces. In FIG. 2B, the wheel-leg components 20 are extended, allowing for rolling locomotion as well as walking. In FIG. 2A, wheel component 210 is shown on ground surface. The wheel is communication with knee component 230 that includes actuation components 240A′, 240B′ that are linked to leg units 240A and 240B. Hip element 250 with engagement units 250A and 250B mate and communicate with the vehicle.

In one embodiment, wheel-leg components 110 include six degrees of freedom. It should be appreciated that while wheel-leg components 110 are controlled collectively to provide rolling and walking locomotion, each wheel-leg component 110 is capable of different movement or positioning during operation. For example, while using wheeled locomotion on an upward slope, in order to maintain the body of vehicle 100 level with flat ground, the front wheel-leg components 110 may be retracted and the rear wheel-leg components 110 be extended. In another example, while using walking locomotion to traverse rough terrain, each wheel-leg component 110, or opposite pairs of wheel-leg components 110 (e.g., front left and rear right), can move differently than the other wheel-leg components 110.

In accordance with the described embodiments, wheeled locomotion is available for use in situations where traditional vehicle travel using rolling wheels is available (e.g., roads and highways). Wheeled locomotion is efficient, when available, for conveyance of a vehicle between destinations. In some embodiments, the wheel-leg components allow active height adjustment of the vehicle to go from street use to off-road use.

In walking locomotion, the vehicle is able to walk up elevations and terrain that is not surmountable using wheeled locomotion. In some instances, walking locomotion allows for nimble and quiet motion, relative to wheeled locomotion. The vehicle is also capable of moving laterally, allowing for quadra-pedal ambulation.

In some embodiments, the use of in-wheel motors frees the suspension from traditional axels and allows ambulation, but also increases the driving performance and adaptability. By using the wheels as feet, the electric motors can lock for stable ambulation, but also have slow torque controlled rotation for micro movements when climbing or self-recovery. In some embodiments, the wheel of the wheel-leg component has the ability to rotate 180 degrees perpendicular to the hub, not only allowing leaning capability while driving, but also giving the wheels enhanced positioning potential when the tire is locked and in walking mode. The wheel could turn 90 degrees and even be used as a wide foot pad lowering the vehicle's PSI footprint when walking over loose materials or fragile surfaces like a snowshoe does.

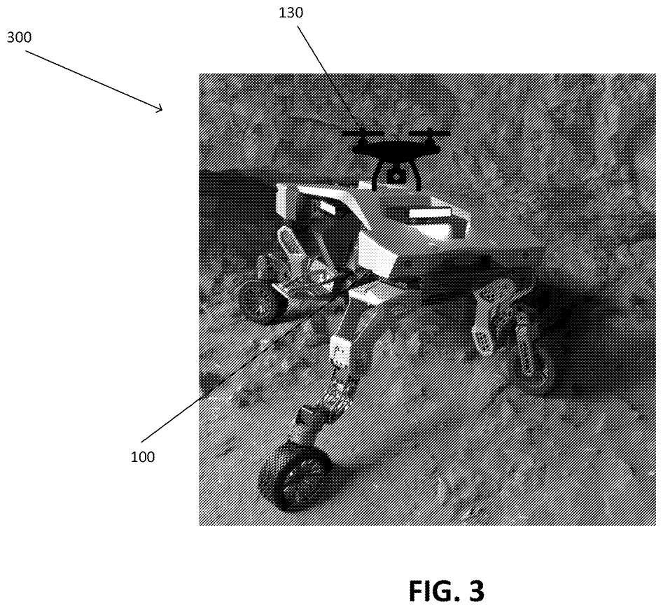

FIG. 3 is an illustration of a walking vehicle 100 with an aerial drone 130 autonomously navigating an underground cavern or mine 300, according to some embodiments. Embodiments described herein leverage the mobility and maneuverability of the autonomous walking vehicle 100 to navigate through a mine or natural cavern, while transporting at least one aerial drone 130 to a location within the mine or cavern. The autonomous walking vehicle 100 is able to navigate to the location using walking ambulation. The aerial drone 130 is equipped with at least one camera or electronic device capable of performing cave mapping. In some embodiments, while the autonomous walking vehicle 100 is navigating the mine or cavern, the aerial drone 130 is configured to perform mapping operations using the electronic device for mapping.

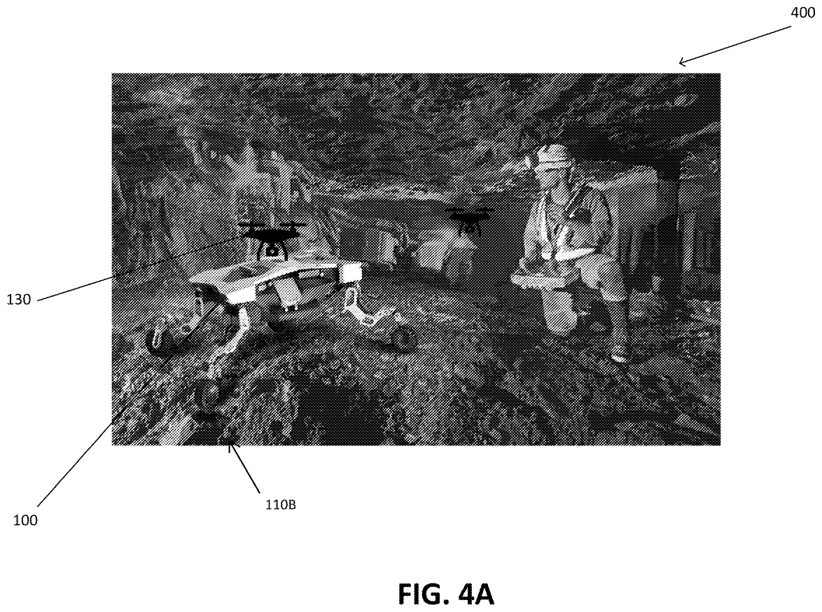

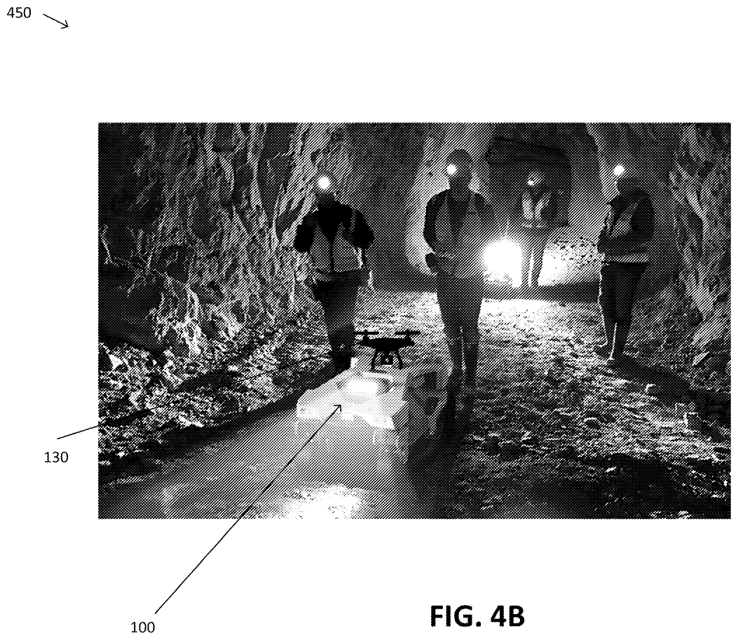

FIGS. 4A and 4B are illustrations of a walking vehicle 100 with an attached aerial drone 130 navigating an underground cavern or mine 400 and 450 while being controlled remotely by a human operator, according to some embodiments. In some embodiments, the walking vehicle 100 is capable of being controlled remotely, e.g., by an operator within the cavern or outside the cavern. It should be appreciated that aerial drone 130 can perform cave mapping operations under remote control of the human operator while attached to walking vehicle 100.

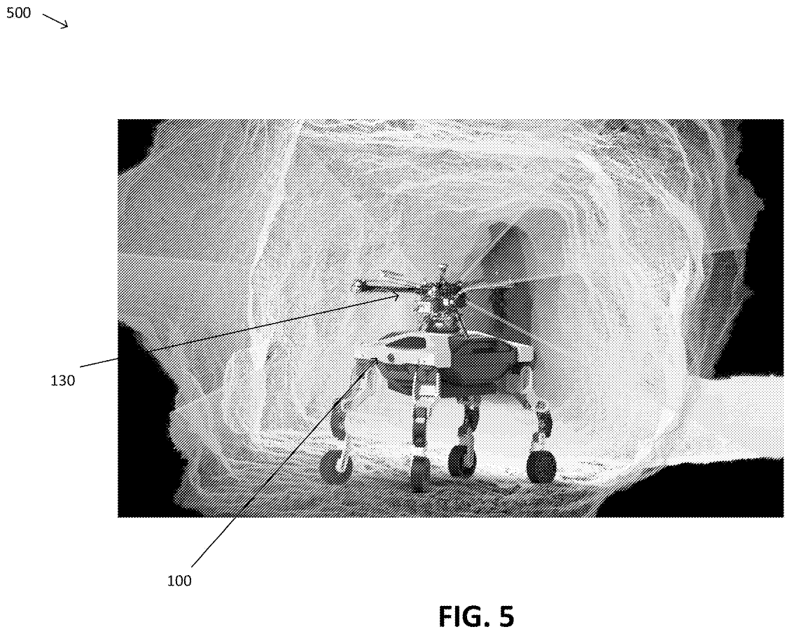

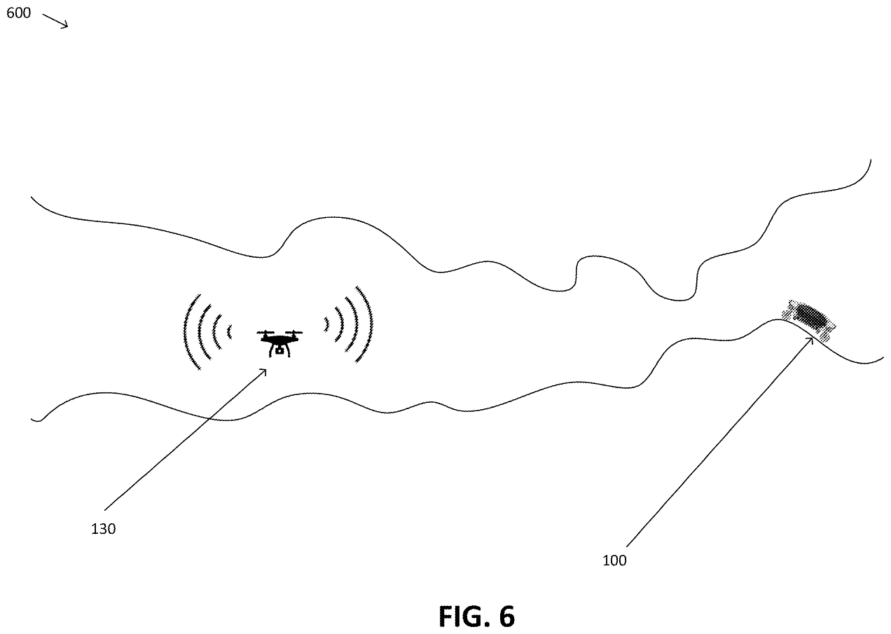

FIG. 5 is an illustration of a walking vehicle 100 with an attached aerial drone 130 performing a mapping operation 500 within a mine, according to some embodiments. Cave mapping is a process whereby the interior passages and caverns of caves are mapped. The aerial drone 130 is equipped with at least one camera or electronic device capable of performing cave mapping. While the walking vehicle 100 is navigating the mine or cavern, the aerial drone 130 is configured to perform mapping operations using the electronic device for mapping.

FIG. 6 is an illustration of a walking vehicle 100 and an aerial drone 130 performing a mapping operation 500 within a mine, according to some embodiments. The aerial drone 130 is equipped with at least one camera or electronic device capable of performing cave mapping. Walking vehicle 100 navigates to a location in the mine, where aerial drone 130 detaches from walking vehicle 100 to begin or continue mapping operation 600. For example, walking vehicle 100 may encounter an insurmountable obstacle, whereby aerial drone 130 detaches to continue performing cave mapping.

FIGS. 7A through 7C illustrate perspective views of different walking gaits of the walking vehicle, according to some embodiments. FIG. 7A illustrates an example view of a vehicle operating in a mammalian walking gait, according to embodiments. The mammalian walking gait positions the legs and support position below the hips, allowing more of the reaction force to translate axially through each link rather than in shear load. In this position each leg is closer to a singularity, meaning that for a given change in a joint angle, the end effector will move relatively little. This results in a relatively energy efficient gait which is well suited for moderate terrain over longer periods of time, but may not be as stable because of the more As discussed, vehicle 100 suitably may have varying dimensions.

FIG. 7A also depicts height r of a wheel-leg component such as 110B, 112B, 114B. That height r can vary depending on the engagement on the engagement of wheel-leg component such as being in a retracted position as shown in FIG. 1A that can be optimal for wheeled location, or if the wheel-leg component is in an extended position as depicted in FIG. 7A which can be optimal for a walking-type locomotion. In a reacted state such as shown in FIG. 1, r suitably may be e.g. up to, less than or more than 0.1, 0.2, 0.3, 0.4, 0.5, 0.6, 0.7, 0.8, 0.9, 1, 1.2, 1.4, 1.6, 1.8, 2, 3 or 4 feet. In a reacted state such as shown in FIG. 1, r suitably may be e.g. up to, less than or more than 0.1, 0.2, 0.3, 0.4, 0.5, 0.6, 0.7, 0.8, 0.9, 1, 1.2, 1.4, 1.6, 1.8, 2, 3, 4, 5, 6, 7, 8, 9, or 10 feet. In general, the height r of a leg-wheel component r suitably may be e.g. up to, less than or more than 0.1, 0.2, 0.3, 0.4, 0.5, 0.6, 0.7, 0.8, 0.9, 1, 1.2, 1.4, 1.6, 1.8, 2, 3, 4, 5, 6, 7, 8, 9, or 10 feet.

FIG. 7B illustrates an example view of a vehicle operating in a reptilian walking gait, according to embodiments. The reptilian walking gait mirrors how animals such as a lizard or gecko might traverse terrain. In this position, the gait relies more heavily on the hip abduction motors which swing the legs around the vertical axis, maintaining a wider stance. This gait position results in a higher level of stability and control over movement, but is less energy efficient. The wide stance results in high static loads on each motor, making the reptilian gait best suited for walking across extremely unpredictable, rugged terrain for short periods of time.

FIG. 7C illustrates an example view of a vehicle operating in a hybrid walking gait, according to embodiments. In addition to reptilian and mammalian gaits, a variety of variants combining the strategies are possible. These variants can be generated through optimization techniques or discovered through simulation and machine learning. These hybrid gaits allow to optimize around the strengths and weaknesses of the more static bio-inspired gaits, transitioning to a more mammalian-style gait when terrain is gentler and a reptilian-style gait in extremely rugged or dynamic environments. In dynamic and highly variable terrains, the vehicle could constantly adjust its gait based on the environment, battery charge, and any number of other factors.

In FIGS. 7A, 7B and 7C, ground-based vehicle 100 includes wheel-leg components 110, 112, 114 and 116 that include depicted leg components 110B, 112B, 114B and 116B extending from the depicted wheels. Site 116 suitably provide releasable engagement of an aerial vehicle component.

In some embodiments, the walking vehicle with an aerial drone described herein can be used in search and rescue operations. Mine caves ins are an unfortunate side effect of underground mining operations. The aerial drone described herein can, operating in conjunction with the walking vehicle, reach locations close to a cave in that might not otherwise be accessible by the walking vehicle or humans. In some embodiments, the aerial drone can deliver goods (e.g., food, water, oxygen) to a site of a cave in, if there is an opening, to any persons in the cave for assisting in rescue efforts.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A vehicle system comprising:
an autonomous ground-based vehicle component configured for traversal over ground using walking locomotion; and
an aerial vehicle component that comprises a drone;
wherein the ground-based vehicle and aerial vehicle components are releasably coupled.

2. The vehicle system of claim 1 wherein the vehicle system has a length less than 8 feet and a height less than 5 feet.

3. The vehicle system of claim 1 wherein the vehicle system has a length less than 6 feet and a height less than 4 feet.

4. The vehicle system of claim 1 wherein the vehicle system is not configured for passenger transport.

5. The vehicle system of claim 1 wherein ground-based vehicle component and/or the aerial component are operated remotely.

6. The vehicle system of claim 1 wherein the ground-based vehicle component and aerial vehicle component are coupled by multiple engagements.

7. The vehicle system of claim 1 wherein the aerial vehicle component comprises a connection mechanism for detachable coupling with the ground-based vehicle component.

8. The vehicle system of claim 1 wherein the ground-based vehicle component and the aerial vehicle component are coupled via a data communication connection.

9. The vehicle system of claim 1, wherein the ground-based vehicle and the aerial vehicle are coupled via an electrical connection.

10. The vehicle system of claim 9, wherein the electrical connection is configured to provide a power transmission between the ground-based vehicle component and the aerial vehicle component, wherein the power transmission is configured to charge a battery of the ground-based vehicle component and/or the battery of the aerial vehicle component.

11. The vehicle system of claim 1, wherein the ground-based vehicle component comprises a removable cargo pod.

12. The vehicle system of claim 11 wherein the aerial vehicle component is configured to travel with the removable cargo pod independent of the ground-based vehicle.

13. The vehicle system of claim 11 wherein aerial vehicle component comprises a unit to retrieve the removable cargo pod from the ground-based vehicle.

14. The vehicle system of claim 1 wherein the aerial vehicle component comprises a rotary wing.

15. The vehicle system of claim 1 wherein the ground-based vehicle and aerial vehicle components are configured to be operated in combination or separately.

16. The vehicle system of claim 1, wherein aerial vehicle comprises electronics for performing cave mapping.

17. A method of operating a vehicle system comprising,
(a) providing a vehicle system that comprises a (i) a ground-based vehicle component and (ii) an aerial vehicle component, wherein the ground-based vehicle component and aerial vehicle component are releasably engaged;
(b) disengaging the ground-based vehicle component and the aerial vehicle component; and
(c) autonomously operating the aerial vehicle component.

18. The method of claim 17 wherein the ground-based component remains stationary while the aerial vehicle component is operated.

19. The method of claim 17 wherein the vehicle system is positioned within a cave or mining area.

20. The method of claim 17 wherein the vehicle system has a length less than 8 feet and a height less than 5 feet.
